(19) United States
(12) Patent Application Publication
(10) Pub. No.: US 2004/0060532 A1
(43) Pub. Date: Apr. 1, 2004

(54) Piston valve internal combustion engine

(76) Inventor: Robert Taylor Scott, Alpharetta, GA (US)

Correspondence Address: Robert T. Scott, 11875 Little Creek Crossing, Alpharetta, GA, 30005, US

(21) Appl. No.: 10/608,754

(22) Filed: Jun. 30, 2003

Related U.S. Application Data
(60) Provisional application No. 60/414,814, filed on Sep. 30, 2002.

(51) Int. Cl. F02N 3/00

(52) U.S. Cl. 123/188.4

(57) ABSTRACT

A multi-valve internal combustion engine using a cam actuated piston/plunger type valve made of metal or other material operating in a companion cylinder with ported passages to the control intake and exhaust functions of an internal combustion engine. The piston valve is fitted with snap type piston rings of the gap sealing design. The piston valve is actuated and controlled by a cam and spring arrangement. Opening of the piston valve is accomplished by spring tension on the valve as rotation of the cam allows the valve to open. As the cam turns, closure is accomplished by the action of the cam against the piston valve.

### CROSS-REFERENCE TO RELATED APPLICATIONS

This application is based upon and claims all rights and priorities under provisional patent application No. 60/414,814 filed Sep. 30, 2002

### BACKGROUND of the INVENTION

This invention relates to a cam actuated piston valve intake and exhaust system for an internal combustion engine. Specifically, a cam actuated piston/plunger type valve operating in a companion cylinder and governing the intake and exhaust functions by opening and closing related air passage ports serving the working cylinder.

Poppet type valves in various configurations are widely used to control intake and exhaust functions for internal combustion engines. While performing satisfactorily, there are some troublesome areas with this type valve including:

a—Cooling, particularly exhaust valves.

b—Passages into and out of cylinder are restricted by valve heads, stems and guides.

c—Warping of valve heads, more so as valve diameter increases.

d—Noisy operation as valves under heavy spring tension cause pounding on valve seats.

e—Leakage due to poor seating.

f—Require more maintenance than other engine parts.

g—Lubrication of small valve stems is difficult.

h—Valve head located inside combustion chamber is exposed to intense heat and interferes with air and gas flow.

i—Size of cylinder bore restricts valve size, particularly on overhead arrangements.

Attempts to improve on the poppet valve include the use of rotating and sliding valves. To date these systems have not proven practical. Prior sliding valve patents addressing these areas include U.S. Pat. No. 4,872,430 Biagini Mar. 29, 1988 and U.S. Pat. No. 5,694,890 Yazdi Oct. 7, 1996.

### BRIEF SUMMARY OF THE INVENTION

This invention utilizes a cam actuated piston valve to control the intake and exhaust functions of an internal combustion engine. The object of this invention is an improved, reliable valve and operating system for an internal combustion engine consisting of a cam actuated piston type valve to replace the presently used poppet valve system. The present invention addresses the problems related to poppet valves outlined above in the Background Section and improves the basic function of intake-exhaust systems consisting of admitting the fuel charge to the working piston and removing combustion gases.

Technology associated with the use of working pistons and piston rings for reciprocating engines is a highly developed, well known and proven concept. Applying the piston and ring concept to intake and exhaust valves eliminates heat, noise and lubrication problems associated with poppet valves. Introduction of larger, unrestricted air passages and valves improves the basic valve functions of intake of fuel charge and exhaust of residual gases Manufacturing is simplified and should prove more economical than poppet valves.

Improvements over the poppet valve include:

a—The piston valve has a significantly larger area exposed to cooled surfaces and lubrication as compared to a poppet valve permitting improved control of engine operating temperature.

b—Sealing is accomplished by use of gap type sealing rings on the piston valve operating in a sleeved or unsleeved cylinder.

c—The system operates quietly as there are no metal valve seats.

d—There are no valve heads to break or warp.

e—There is no valve action inside the combustion chamber permitting a free running engine. There is almost no possibility of internal engine damage due to failure or partial failure of the piston valve.

f—The piston valve made of metal or other materials is installed in a machined head or machined and mated with a liner/sleeve and installed in the head. Port openings in the cylinder or liner wall are spaced and beveled to accommodate a piston using piston rings. Using a matched unit simplifies manufacture and maintenance.

g—Maintenance when required is simplified as the piston valve and liner are easily accessed and when designed as a unit can be quickly replaced as a unit. The action of the cam driven piston valve is comparable to a working piston with reduced piston travel. The stroke of the piston valve is limited and in four cycle engines the piston operates at ½ the RPM of the working piston. Piston valves should exceed the life of working pistons without requiring service.

h—Ordinarily one intake and one exhaust valve would adequately fuel and scavenge the engine. Should more air/gas volume be desired, the piston valve design will accommodate multiple valves per cylinder and also permit larger valve diameters. The larger passages improve the basic functions of intake and exhaust. Cylinder displacement is slightly increased with the piston valve design, more so as valve diameter is increased.

### BRIEF DESCRIPTION of the SEVERAL VIEWS of the DRAWINGS

FIG. 1—Working piston and cylinder with overhead piston valve.

FIG. 2—Piston valve

FIG. 2A—Valve cylinder sleeve/liner

FIG. 3—Cross section of FIG. 1 at 3-3 section line.

FIG. 4—Bottom view of cylinder head with a 4 valve arrangement

### REFERENCE NUMBERS

1—Cam lobe

2—Piston valve. While a shoulder is shown on the valve, other type retainers could be used to tension the spring.

2A—Valve cylinder sleeve/liner

3—Section line

4—Spring

5—Air/gas passage

6—Piston ring of gap seal design

7—Spark plug or spray valve

8—Combustion chamber

9—Working piston

10—Bottom of cylinder head

### DETAILED DESCRIPTION of the INVENTION

While engines can be multi-valve and multi-cylinder in various valve configurations, the following details and drawings are limited to one valve to describe and explain the piston valve system. This invention utilizes a cam driven piston/plunger type valve operating in a companion cylinder in conjunction with ports to control intake and exhaust functions of an internal combustion engine. The camshaft gearing and valve timing operate in normal fashion for four cycle engines as well as two cycle engines that use a poppet valve. In the piston valve design, the high point of the cam lobe closes the piston valve whereas the low point allows the piston valve under spring tension and pressure within the working cylinder to open. The intake and exhaust passages to the working cylinder basically conform to present designs. However, instead of opening and closing the throat of the passage by a poppet type valve opening into the combustion chamber which exposes the valve head and stem to hot gases, the passage is opened and closed by a piston valve exposing (open) or blocking (close) the ported area of the passage.

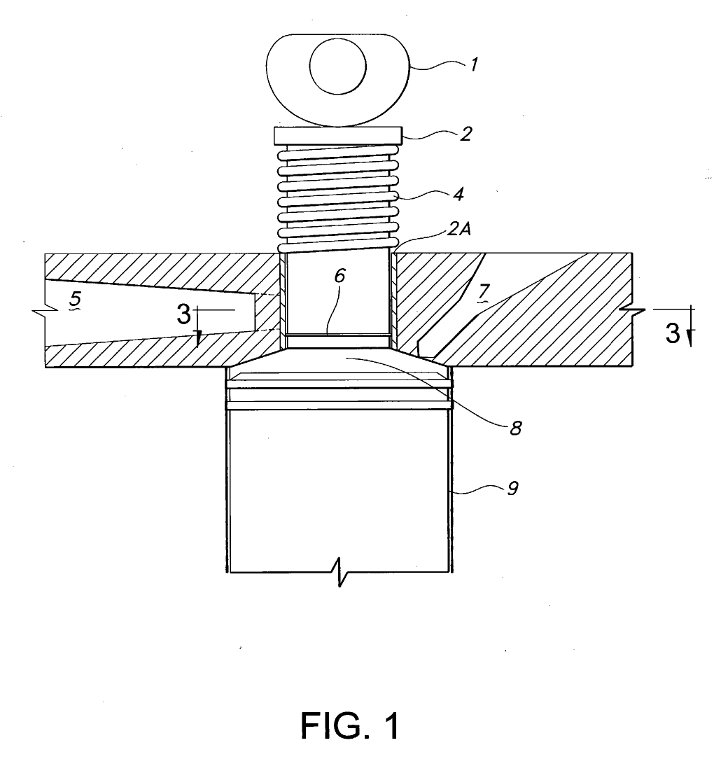

FIG. 1 represents a working piston and cylinder with a piston/plunger type overhead valve. The cam lobe (1) acts either directly or through a tappet on the piston valve (2) which is spring tensioned (4). Spacers or other means of adjustment are provided between the cam and piston valve. Rotation of the cam lobe forces the piston valve downward past the air passage (5) and seals the opening into the cylinder closing the air passage. As the cam turns, the lobe allows the piston valve under spring tension and pressure from within the cylinder to move upward or open. Gap sealing ring/rings (6) are used as needed. The spark plug or spray valve (7) serves the combustion chamber (8). Valve timing, intake, compression, power and exhaust strokes of the working piston (9) operate in the normal fashion for internal combustion engines.

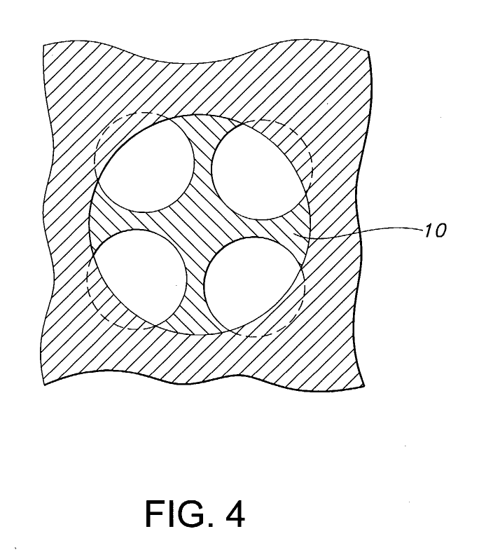

FIG. 4 shows a bottom view of a 4 unit piston valve overhead arrangement. Each of the piston valve openings extends beyond the bore of the working piston adding area to the combustion chamber when valves are in the open position. In most cases valve size confined to the bore area will be adequate. However, larger valves are easily accommodated as illustrated. Two or more piston valves can be used. When closed the piston valves fill this area with little or no effect on the design of the combustion chamber. Piston valve and air passage size are not limited by the bore size of the working cylinder thus permitting larger air passages and piston valves. Larger volumes of air/gas can move quickly in and out of the cylinder. Breathing is the term used to described intake/exhaust action. Valve systems in modern engines seek to improve breathing through the use of multiple valves and cams per operating cylinder. The larger the valve diameter and air passage, the better the engine performance. However, in the overhead valve design the bore diameter of the working cylinder restricts the diameter of the poppet valves whereas the piston valve is not so restricted

On the overhead design the piston valve adds to the total cylinder volume as the intake piston valve is distal from the working cylinder or open when the cylinder is charged. On closure there is a positive effect on compression as the intake piston valve closes the passage sealing the combustion chamber The gas pressure produced by combustion within the working cylinder augments spring tension used to open the exhaust valve. In turn this permits light duty return springs on the exhaust valve. This effect is not as significant on intake valve operation.

The overhead system is the preferred embodiment. However, the piston valve is easily adaptable to side valve engines.

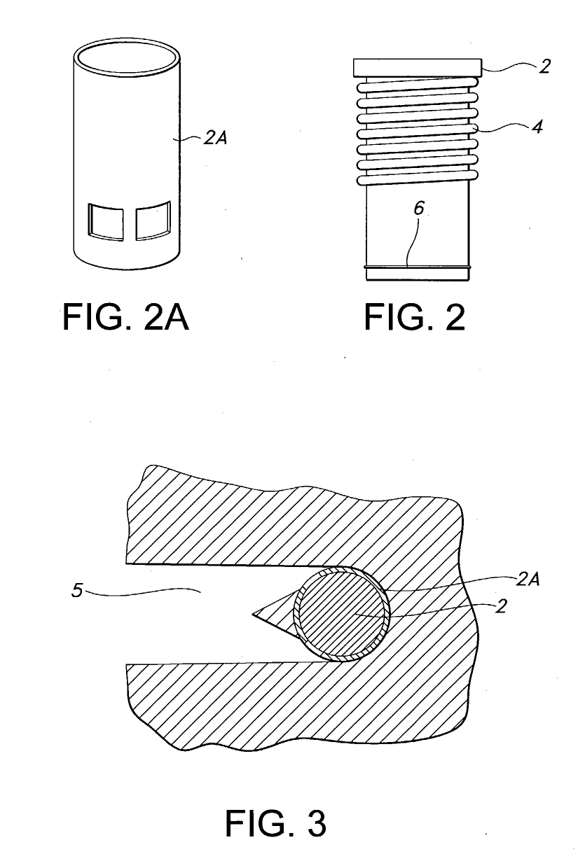

While there are some similarities to the expired Biagini patent which is disclosed as a sliding valve substantially cylindrical in shape, the basic claims of the Biagini patent relate to a cylindrical or oval shaped part of the valve providing the sealing means with movement of the valve directed outside or away from the working piston. There is no disclosed or claimed operating mechanism. Commercial use of the invention is not known. The present invention adapts the piston and port action of the well known two cycle engine design to an operating valve system using a piston to replace the poppet valve. The piston valve uses at least one gap type sealing ring where the ring gap is sealed as well as the sealing action between the piston valve and cylinder wall. The invention also uses large diameter valves with actuation by a cam system using a direct action closure action with spring tensioned valve opening action. Use of larger valves with related unrestricted passages significantly improves the breathing characteristics of the engine. The invention uses a piston valve FIG. 2 and mated liner FIG. 2A which simplifies the manufacturing process.

The present invention is disclosed with the preferred embodiment but it should be understood that changes could be introduced by those skilled in the art without departing from the scope of the invention. This scope of the invention is limited only as defined by the following listed claims:

01- What I claim as my invention is a cam actuated piston/plunger type cylindrical shaped valve operating in a reciprocal fashion, installed in a companion cylinder and working in conjunction with ported passages in the valve cylinder wall to open and close related air passages that govern the intake and exhaust functions of a multi-valve internal combustion engine.

02- The piston/plunger valve described in claim 1 is comprised of a piston/plunger fitted to a separate ported liner and installed in the engine as a replaceable unit.

03- The invention described in claim 1 is installed in the working cylinder head of overhead valve design engines

04- The invention described in claim 1 is installed in the block of side valve design engines.

05- The piston/plunger valve described in claim 1 is cam actuated using a cam lobe shaped where the high point of the lobe provides and maintains positive valve movement to the closure position and the low point of the cam lobe permits the valve under spring tension to move to the open position.

06- The piston/plunger valve described in claim 1 is actuated by direct cam action or through a levered arrangement.

07- The piston/plunger valve described in claim 1 uses valve diameter sizes in overhead designs that extend the valve edge past or outside the bore area of the working piston.

08- The piston/plunger described in claim 1 uses valves sized to fit within the bore area of the working piston in overhead designs.

09- The piston/plunger described in claim 1 is fitted with 1 or more snap type piston rings of gap sealing design where the gap area and wall area are both sealed.

10- The piston/plunger and liner described in claim 2 are made of metal.

11- The piston/plunger and liner described in claim 2 are made of material other than metal.

12- The piston/plunger described in claim 1 and 2 is of a solid cylindrical design.

13- The piston/plunger described in claim 1 and 2 is of a skirted design.

14- The piston/plunger described in claim 1 and 2 is hollow with a closed end facing the combustion area of the working piston.
